(19) United States
(12) Patent Application Publication
(10) Pub. No.: US 2011/0178854 A1
(43) Pub. Date: Jul. 21, 2011

(54) METHOD AND SYSTEM FOR ENHANCING AND/OR MONITORING VISUAL CONTENT AND METHOD AND/OR SYSTEM FOR ADDING A DYNAMIC LAYER TO VISUAL CONTENT

(75) Inventors: Tzahi Sofer, Tel-Aviv (IL); Guy Tomer, Tel Aviv (IL)

(73) Assignee: Somertech Ltd., Tel-Aviv (IL)

(21) Appl. No.: 13/061,713

(22) PCT Filed: Sep. 3, 2009
(86) PCT No.: PCT/IL2009/000855

§ 371 Date: Mar. 2, 2011

Related U.S. Application Data
(62) Division of application No. 61/094,085, filed on Sep. 4, 2008.

(51) Int. Cl. G06F 3/01; G06Q 30/00; G06F 15/16

(52) U.S. Cl. 705/14.4; 715/738

(57) ABSTRACT

A method for superimposing interactive components on a visual content displayed on at least one client terminal. The method comprises receiving a designation of at least one interactive component from a plurality of interactive components, associating between the designation and a visual content item, and forwarding the designation to a client terminal so as to allow a presentation of the at least one interactive component in a manner that the presentation coincides with a display of the visual content item by a plurality of client terminals connected to a network. The at least one interactive component is superimposed on the display during the presentation.

### RELATED APPLICATION

This application takes priority of a U.S. Provisional Patent Application No. 61/094,085, filed on Sep. 4, 2008. The content of the above document is incorporated by reference as if fully set forth herein.

### FIELD AND BACKGROUND OF THE INVENTION

The present invention, in some embodiments thereof, relates to systems and methods for managing interactive components, such as widgets and, more particularly, but not exclusively, to systems and methods for managing interactive components presentation.

During the last decade widgets have become a common tool for providing data and entertainment. A widget (also known as gadgets, badges, or modules, among other names familiar to those skilled in the art) provides a single interaction point for a direct manipulation of a given kind of data. Usually, a widget has a specialized graphical user interface (GUI) module that provides visual information and/or easy access to functions such as clocks, forecasts for particular cities, current stock price of a certain company, news in a particular geographical area, news related to a particular topic, general news feeds, images, video files, calendars, news aggregators, calculators and desktop notes. These kinds of widgets are usually hosted by a client components engine, a service that runs and displays the widget on another GUI, such as that of the desktop.

As is known in the art, web-based widgets enable end users to embed various third-party functionality into their web pages. The inclusion of a widget in a web page can be accomplished through JavaScript™, an EMBED element, an embedded Flash™ object, or other methods which bring the widget code into the web page, where the widget runs locally within a user's browser. While the widget code can consist entirely of Hypertext Markup Language (HTML), widgets also may be developed in either JavaScript™ or Adobe™ Flash™ or Microsoft Silverlight.

Some technologies have been developed to facilitate adding widgets to multimedia display, for example as described in U.S Patent Application No. 2007/10162850, published on Jul. 12, 2007 that describes systems, methods, computer-readable mediums, user interfaces and other implementations are disclosed for defining, installing, launching, managing, displaying and operating sports-related widgets in a display environment. The sports related widgets can be configured to provide information related to sporting events.

Another example is provided in U.S Patent Application No. 2008/0120664, published on May 22, 2008 that describes a content processing device which is configured to store a parameter indicative of a content preference of a system user, to request and receive data relating to the stored parameter, to receive an incoming video signal, and to provide to a video display at least a portion of the video signal and a data interface including at least a subset of the data.

### SUMMARY OF THE INVENTION

The present invention, in some embodiments thereof, relates to interactive components and, more particularly, but not exclusively, to method and system for superimposing interactive components on a display of visual content.

According to some embodiments of the present invention there is provided a method for superimposing interactive components on a visual content displayed on at least one client terminal. The method comprises receiving, from a content provider of a visual content item, a designation of at least one interactive component from a plurality of interactive components; associating between the designation and the visual content item and forwarding the designation to a client terminal so as to allow a presentation of the at least one interactive component, the presentation being synchronized to coincide with a display of the visual content item by each of a plurality of client terminals connected to a network. The at least one interactive component is superimposed on the display during the presentation.

Optionally, the visual content item is selected from a group consisting of a video stream, a video transmission, a video unicast, a video, a video file, an animation file, an animation steam, a video in demand (VOD) record, an animation transmission, a presentation file, a presentation steam, an online game, a presentation transmission.

Optionally, the plurality of client terminals are selected from a group consisting of computers, Smartphones, laptops, netbooks, personal digital assistant (PDAs), Internet Protocol Television (IPTV) devices, cell phones, game consoles and set top boxes, televisions (TVs).

Optionally, the designation define for a group of the at least one interactive component a time slot during the display, the group being displayed during the time slot.

Optionally, the method further comprises managing a timeline for each the visual content item and updating the presentation according to the timeline.

Optionally, the method further comprises monitoring at least one event held on at least one of the plurality of client terminals and updating the presentation according to the at least one event.

Optionally, the method further comprises embedding promotional content into at least one of the at least one interactive component and an additional component superimposed on the display.

Optionally, the method further comprises analyzing the visual content item and changing the presentation according to the analyzing during the display.

More optionally, the analyzing is performed substantially during the display.

Optionally, the method further comprises monitoring a plurality of interactions of a plurality of viewers with the at least one interactive component during the display.

More optionally, the method further comprises updating the presentation according to an analysis of the plurality of interactions.

More optionally, the method further comprises generating a report according to the plurality of interactions.

More optionally, the generating is performed during the display.

More optionally, the method further comprises recording the plurality of interactions and playing the plurality of recorded interactions during a replay of the visual content item.

Optionally, the method further comprises monitoring at least one viewer interaction with the at least one interactive component during the presentation so as to allow at least one of changing the presentation, removing the at least one interactive component, and presenting a report according to the at least one viewer interaction.

Optionally, the at least one interactive component allows presenting content pertaining to the visual content item.

According to some embodiments of the present invention there is provided a system for superimposing interactive components on a visual content displayed on at least one client terminal. The system comprises a repository hosting a plurality of interactive components and a distribution module for receiving a designation of at least one of the plurality of interactive components for a visual content item via a communication network and transmitting the designation to a plurality of client terminals so as to allow each the client terminal to synchronize a presentation of the at least one interactive component to coincide with a display of the visual content item.

Optionally, each the client terminal comprises a player having a client engine for performing the presentation and the display.

Optionally, each the client terminal comprises a player wrapped in a client engine so as to allow the performing of the presentation and the display.

Optionally, the client engine manages at least one container for containing the at least one interactive component so as to allow the performing of the presentation; wherein the at least one container facilitate at least one of manipulating the at least one interactive component, changing the size of the presentation, and relocating the presentation.

Optionally, the distribution module is configured for receiving a consumer profile and selecting the plurality of client terminals according to a match between the consumer profile and a plurality of client profiles associated with the plurality of client terminals.

Optionally, the system further comprises an advertising module for receiving promotional content and for at least one of embedding the promotional content in the at least one interactive component during the presentation and instructing the plurality of client terminal to present the promotional content during the display.

Optionally, the system further comprises a commerce module for billing a provider of the visual content item according to the designation.

Optionally, the system further comprises a viewer module for receiving a designation of at least one of the plurality of interactive components and adding the at least one interactive component to the presentation.

According to some embodiments of the present invention there is provided a system for managing a marketplace of interactive components. The system comprises a component repository storing a plurality of interactive components received from plurality of component providers via a communication network, a distribution module for receiving a plurality of designations each of at least one of the plurality of interactive components from at least one content provider via the communication network, and a commerce module for crediting at least one of the plurality of component providers and billing at least one of the at least one content provider according to the designation.

Optionally, the commerce module being configured for billing the at least one content provider according to respective the plurality of designations.

Optionally, the system further comprises an advertising module for receiving a request for embedding promotional content in at least one advertising spot in at least one of the plurality of interactive components, wherein the commerce module being configured for billing at least one advertiser according to the request.

More optionally, each the interactive component is associated with a payment model, the commerce module being configured for billing the at least one advertiser according to a respective the payment model of the at least one interactive component.

Optionally, the designation is associated with a visual content item, the at least one interactive component being transmitted to a plurality of client terminals so as to allow each the client terminal to synchronize a presentation of the at least one interactive component to coincide with a display of the visual content item.

According to some embodiments of the present invention there is provided a method for superimposing interactive components on a visual content displayed on at least one client terminal. The method comprises receiving a designation of at least one interactive component from a first source via a communication network, receiving a visual content item from a second source, providing at least one container for containing the at least one interactive component, generating a presentation of data from the at least one interactive component in the at least one container, superimposing the at least one container on a display of the visual content item, and allowing a user to manipulate the at least one container so as to adjust the presentation.

Optionally, the visual content item is received from a multimedia distribution network, the communication network being the Internet.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volitile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an interactive components system and a plurality of clients which are communicating therewith to allow the superimposing of one or more interactive components on visual content items, according to some embodiments of the present invention;

FIG. 2 is a schematic illustration of the interactive components system of FIG. 1 and a multimedia distribution network for providing visual content items, according to some embodiments of the present invention;

FIG. 3 is a flowchart of a method for superimposing interactive components on visual content items which are provided to client terminals via a network, according to some embodiments of the present invention;

FIG. 4 is an image of an exemplary GUI that allows an operator to select one or more interactive components for its visual content items, according to some embodiments of the present invention;

FIGS. 5A-5E are images of exemplary media player displays which are superimposed with interactive components, according to some embodiments of the present invention;

FIG. 6 is a flowchart of a method for superimposing interactive components on a display of a media player, according to some embodiments of the present invention;

FIG. 7 is an image of an exemplary GUI for monitoring a chat widget, according to some embodiments of the present invention;

FIG. 8 is an image of an exemplary GUI for displaying statistical data pertaining to the monitored interactions between user selected interactive components, according to some embodiments of the present invention; and

FIG. 9 is an image of an exemplary GUI displaying an outcome of a poll held by a poll widget superimposed on a visual content item, such as a NBA game, according to some embodiments of the present invention.

### DESCRIPTION OF EMBODIMENTS OF THE INVENTION

The present invention, in some embodiments thereof, relates to systems and methods for managing interactive components, such as widgets and, more particularly, but not exclusively, to systems and methods for managing interactive components presentation.

According to some embodiments of the present invention there is provided a system and a method for allowing a content provider, such as a website and/or a video broadcaster, to superimpose one or more interactive components, such as widgets, on a visual content item it provides. In these embodiments, the system allows content providers to designate one or more interactive components from a gallery to a visual content item, such as a broadcast, a video stream, an online game, and/or a video in demand (VOD) record, it provides over a network such as the Internet or a multimedia distribution network. Then, one or more client terminals, such as personal computers, cellular phones, and/or set top boxes, are instructed to superimpose a presentation of the designated interactive components on a display of the visual content item. In such a manner, the content provider may enrich the display of the visual content item and target different visual content items to different viewers, under certain considerations.

Optionally, the superimposition of the interactive components is performed by a component engine, such as a plug-in, which is installed on a media player executed by a client terminal. Optionally, the superimposition of the interactive components is performed by a component engine that wraps a media player executed by a hosting client terminal.

Optionally, the system may be used for embedding promotional content on the interactive components and/or on advertising components which are superimposed on the display of the visual content items.

Optionally, the system allows designating interactive components with different time slots during the display of the video content items. In such a manner, the designating interactive components, which are available to the viewer, may change during the display, optionally according to a predefined timeline and/or according to an analysis of the visual content item in real time.

Optionally, the viewer interactions with the designated interactive components are monitored by the system. Such monitoring allows generating reports pertaining to the viewers' viewing habits and/or to moderate or otherwise direct the interaction of viewers with the presented interactive components.

According to some embodiments of the present invention, there is provided a system for managing a marketplace of interactive components and optionally advertising spots which are related thereto. In such an embodiment, the system may manage interactive components gallery of interactive components which are provided by component providers, such as application developers, brands, creators and designers. The system allows content providers to designate one or more interactive components for their media items, as outlined above and described below, and bills them according to their designations. Optionally, the system credits the component providers according to the designations of the content providers.

Optionally, the system is designed to allow advertisers to select one or more advertising spots for promotional content on the interactive components and/or on advertising components, such as pop ups. In such an embodiment, the system may credit the component provider that its interactive component has been used for displaying the promotional content and/or the content provider that provided the video content item which has been displayed during the presentation of the promotional content.

Optionally, the system allows component and/or content providers to define different method payments and/or rates for the advertising spots which are related thereto.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

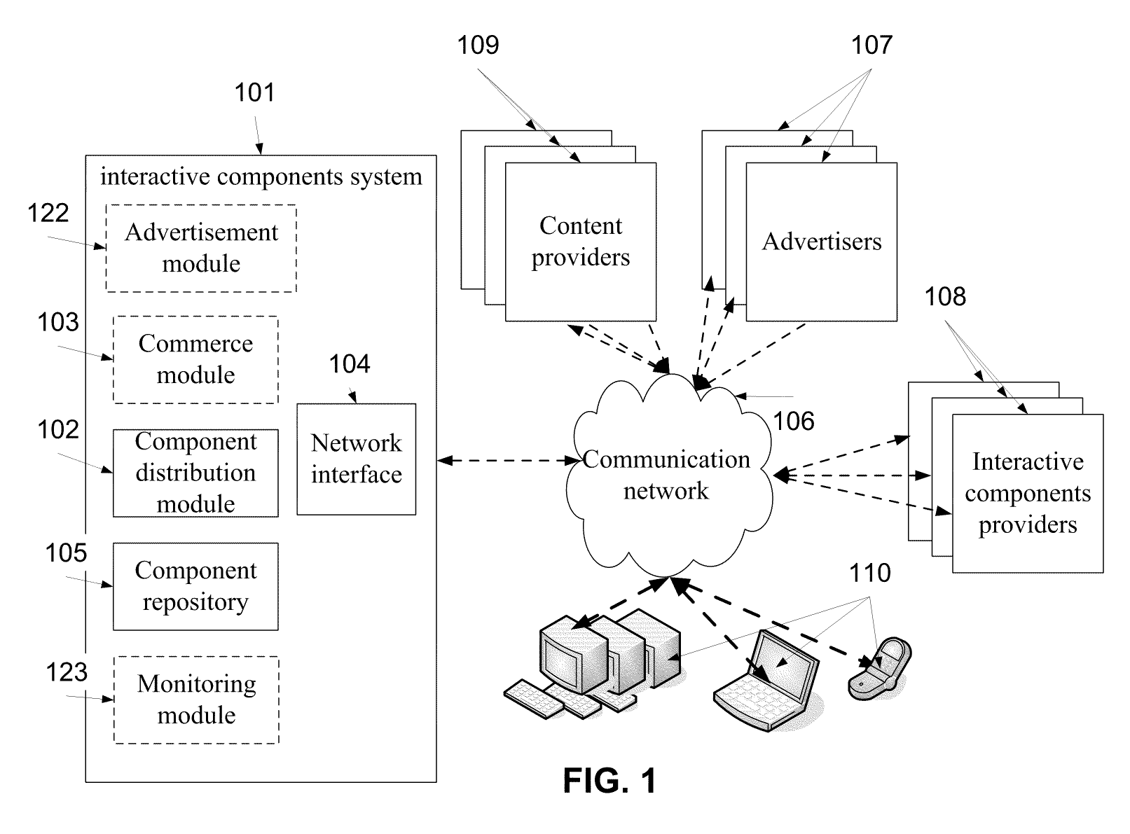

Reference is now made to FIG. 1, which is a schematic illustration of an interactive components system 101 and a plurality of optional clients 110, 107, 108, and 109 which are communicating therewith to allow the superimposing of interactive components on one or more visual content items, according to some embodiments of the present invention. The superimposition is optionally performed by rendering methods, for example methods of displaying transparent or semi transparent objects within a rich interactive application (RIA) containing a video broadcast, as known in the art.

As used herein, an interactive component means a portable chunk of code, such as a Dynamic HTML (DHTML) code, HTML5 code, a JavaScript code, Adobe Flash code, Microsoft Silverlight code, Sun JavaFX code or other that may be installed and executed within a webpage and\or within an RIA, such as a Hyper Text Markup Language (HTML)-based web page without requiring additional compilation, a widget, an itool, a social network component, and the like. As used herein, a visual content item means a visual and/or audiovisual content, stream, transmission, unicast, and/or broadcast, for example a video file, steam, and/or transmission, an animation file, steam, and/or transmission, a presentation file, steam, and/or transmission, and/or any other visual and/or audiovisual content.

As depicted in FIG. 1, the interactive components system 101 and the clients 105, 107, 108, and 109 are communicating via a communication network 106, such as a packet switched communication network 106, for example an internet protocol (IP) network. As such, communication network 106 uses known protocols for transporting data, such as user datagram protocol (UDP), transport control protocol (TCP), hypertext transfer protocol (HTTP), and the like. Further, communication network 106 may include a wide area network (WAN), such as the Internet, a local area network (LAN), and the like.

Optionally, the interactive components system 101, which may be implemented on a server, referred to herein as a component server 101, includes and/or connected to a component repository 105 that hosts a plurality of interactive components and/or facilitate access thereto, for example via the communication network 106.

Optionally, the component server 101 includes an input/output interface 104, such as one or more network ports, for receiving and outputting data via the communication network 106, and an interactive components distribution module 102, referred to herein as a distribution module 102, that manages the communication with one or more of the clients 105, 107, 108, and 109 via the interface 104.

As depicted in FIG. 1, one or more content providers 109 are connected to the component server 101 via the communication network. Optionally, a content provider means a website and/or a database based entity, an internet broadcaster and/or a network node that provides visual content items over the communication network. Optionally, the content provider may manage, directly or indirectly, one or more sources of visual content items. The visual content items may or may not be provided by the content provider itself.

In such an embodiment, the content providers 109 provide visual content items to some or all of the client terminals 110, which are optionally computers, servers, laptops, netbooks, Smartphones, cellular phone, Internet Protocol Television (IPTV) clients and the like via the communication network 106. For clarity, though the communication network 106 is depicted as a single network, it may include any number of networks and sub networks. As used herein a client terminal means a computer, a Smartphone, a laptop, a personal digital assistant (PDA), a cell phone, an Internet Protocol Television (IPTV) device, a set top box, a game console.

Optionally, the component server 101 further comprises a commerce module 103, am advertisement module 122, and/or a monitoring module 123 which are described in further detail below.

Optionally, the component server 101 manages the superimposition of a plurality of interactive components on a plurality of visual content items of a plurality of content providers 109. These content providers 109 and other clients 108, 107, and/or 105 may simultaneously communicate with the component server 101, for example using Web Access technology and other APIs. Optionally, the communication is secured, for example using a Sandboxed environment for the different components. In such a manner, different clients 105, 107, 108, and/or 109 may receive unique keys which are generated for accessing data pertaining thereto.

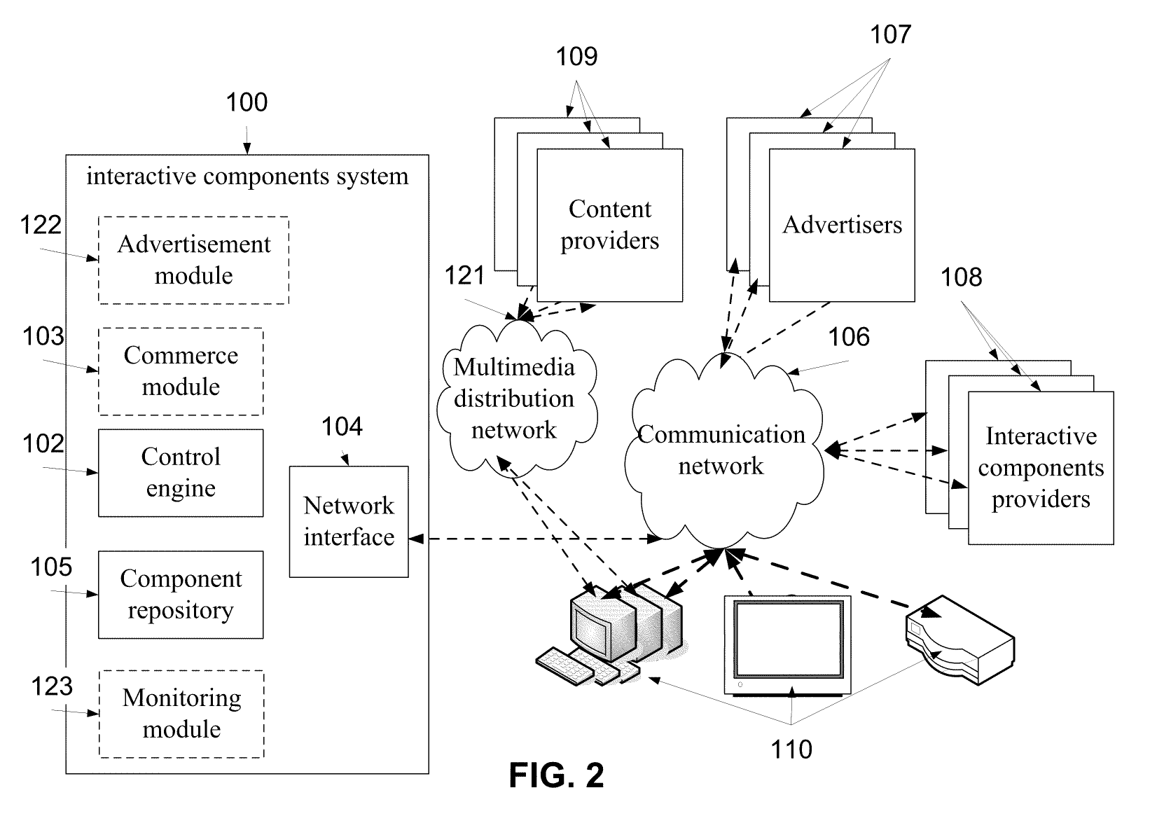

Reference is now also made to FIG. 2, which is a schematic illustration of the component server 101 and the clients 105, 107, 108, and 109 as provided in FIG. 1, according to some embodiments of the present invention. In addition to the elements of FIG. 1, FIG. 2 depicts a multimedia distribution network 121 that connects some or all of the content providers 109 to some or all of the client terminals 110, according to some embodiments of the present invention. For clarity, though the multimedia distribution network 106 is depicted as a single network, it may include any number of networks and sub networks.

In such an embodiment, the content providers 109 are connected to the multimedia distribution network 121 for providing a multimedia signal, such as a video signal, for example as known in the art. For clarity, the content provider may not physically provide the multimedia signal. For example, the multimedia signal may be provided using any content delivery network (CDN). For example, network 121 may include hardware and software for providing multimedia signal via coaxial cable and/or fiber optic cable, for example Community Antenna Television (CATV) and/or wirelessly, for example via a satellite communication. As is known, a multimedia signal, such as a video signal may be provided to the multimedia distribution network 121 from a head end. In such an embodiment, the content providers 109 provide video and/or audio streams to some or all of the client terminals 110, which are optionally, a television with an internet connection, such as a high definition television (HDTV) with internet connection and an IPTV and/or set top boxes, such as cable set top boxes, and satellite set top boxes. The multimedia signal may be based on the Digital Video Broadcast-Handheld (DVB-H) standard or other DVB standards, such as DVB-MHP, DVB-Satellite (DVB-S), DVB-Terrestrial (DVB-T) or DVB-Cable (DVB-C). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting-Terrestrial), DAB (Digital Audio Broadcasting), DMB (Digital Multimedia Broadcasting), FLO (Forward Link Only) or DIRECTV, which the specification thereof are incorporated herein by reference. It should be noted that the networks 106, 121 and/or the transmission signals may be combined into a single network and/or a common signal.

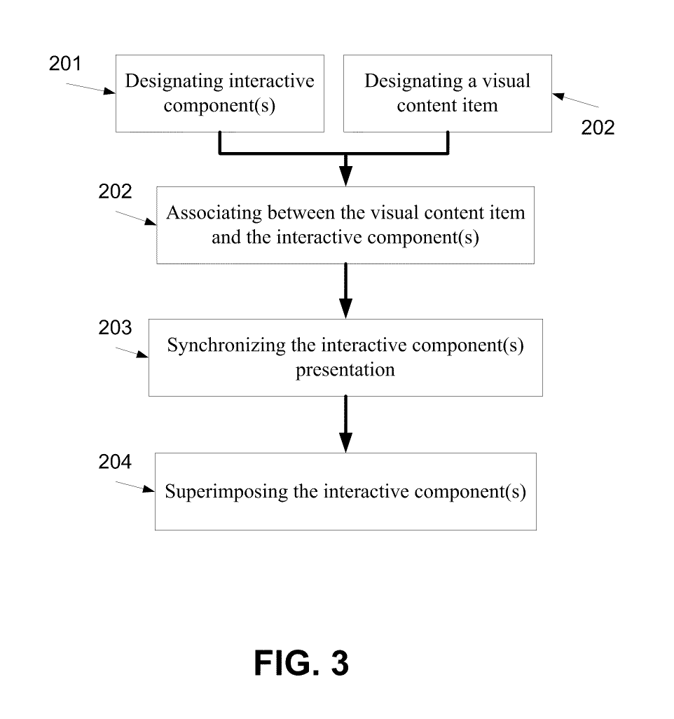

Reference is now also made to FIG. 3, which is a flowchart of a method 200 for superimposing interactive components, such as widgets and widgets designated to visual content items, on a display of content media items which are provided to client terminals, such as the client terminals 110, according to some embodiments of the present invention. Such a superimposition enhances the display of the content media items, provides an interactive dimension to a content visual item such as a video stream, and/or allows monitoring viewer interactions which are held during the display.

The method 200 allows a content provider to superimpose a dynamic layer of interactive components on a display of a visual content it provides. In such a manner, the content provider determines which interactive components are available to its consumers via the client terminals. These consumers may be subscribers, content purchasers, website visitors and/or the like. As further described below, the dynamic layer allows the content provider to enhance the visual content, to add promotional content thereto and/or to monitor the viewer interactions between the consumers and the interactive components during the presentation the visual content. Optionally, the method does not require from the content provider to upgrade its infrastructure and/or visual content items in advance and/or to provide new peripheral devices to the consumers.

First, as shown at 201 a set of one or more interactive components is designated per visual content item and/or a group of visual content items, for example by manual and/or automatic selection. For clarity designation and selection may be referred to herein interchangeably.

According to some embodiments of the present invention the component server 101 provides the content providers 109 with an access to a GUI via a client terminal, such as a computer which is connected to the communication network 106. As described above, the component server 101 manages a repository with a plurality of interactive components, such as widgets, or references thereto. The plurality of interactive components or references thereto may be referred to herein as an interactive components gallery. Optionally, the interactive components gallery includes general widgets, such as a social network widget, a calendar widget, a new feeds widget, a chat widget, and the like. Optionally, the interactive components gallery includes designated interactive components, which are designed to be updated according to content that is associated and/or taken from certain visual content items, for example sport service widgets as described in U.S Patent Application No. 2007/10162850, published on Jul. 12, 2007, which are incorporated herein by reference. Other designated interactive components may be polls widgets that display polls' outcome and/or allows the user to participate in a poll, a chat widget that allows discussing the visual content with other viewers watching it, applications for sport fans and/or reality shows visual content, for example as described below, designated search and/or information widget that allows searching content pertaining to the visual content and the like.

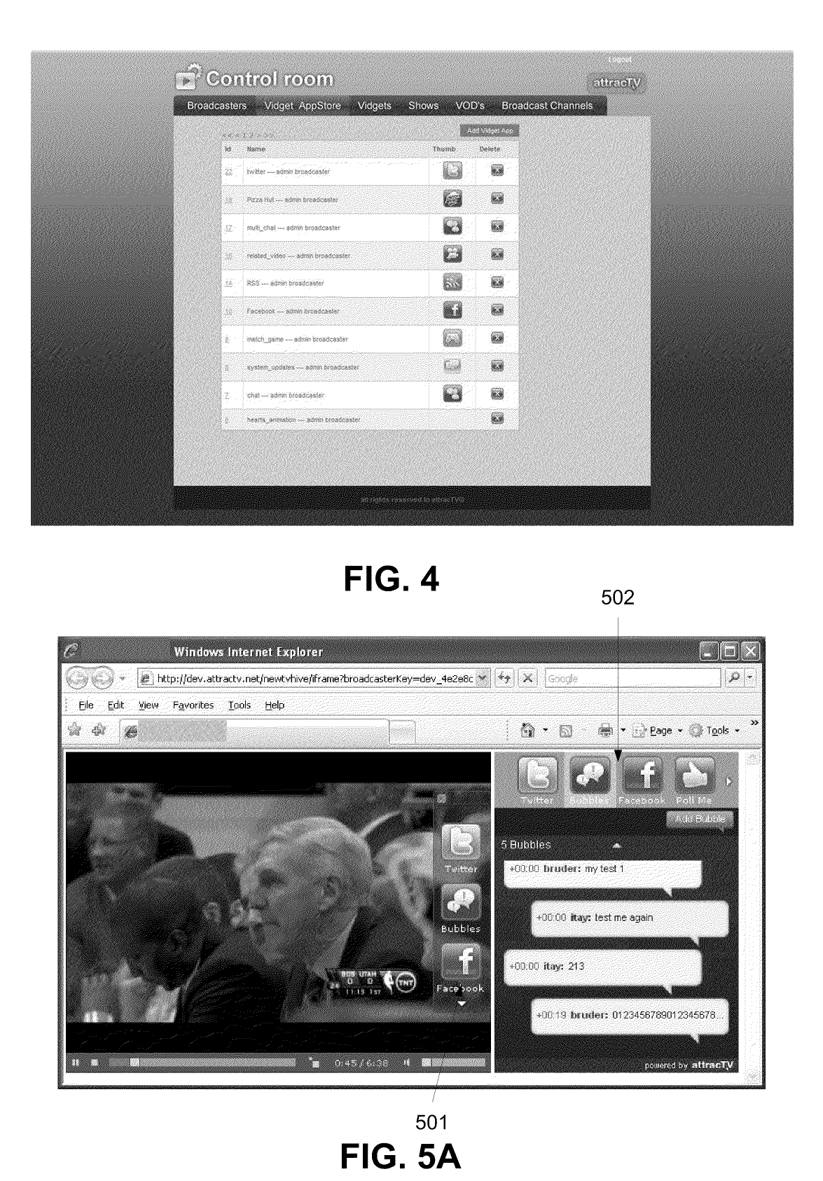

In use, the GUI allows the content providers 109 to designate one or more interactive components from the interactive components gallery. For example, FIG. 4 depicts a GUI that displays a group of interactive components from the gallery and allows an operator to designate one or more interactive components, according to some embodiments of the present invention. For example, FIG. 4 depicts a GUI that displays a group of interactive components from the gallery and allows an operator to designate one or more interactive components, according to some embodiments of the present invention. It should be noted that the designation, which may be referred to as a selection, of available interactive components may be performed automatically, for example according to an engine that selects the interactive components according to a set of predefined rules.

As shown at 202, the designated set is associated with a visual content. For example, the content provider may use the aforementioned GUI to designate and/or to select the visual content that is associated with the designated set.

According to some embodiments of the present invention, the component server 101 manages a timeline for each visual content item. In such a manner, different sets may be associated with different time slots. Such a timeline allows superimposing different interactive components during different time slots of the display of the visual content item. In such an embodiment, a content provider, such as an internet broadcaster, may select a certain time slot the designated set is superimposed on a certain video which is streamed and/or broadcasted and/or a certain display time in a media file, such as a video in demand (VOD) record.

Additionally or alternatively, the timeline record allows the content providers 109 to define the order and/or timing of the presentation of the interactive components in the set, the order and/or the timing of the presentation of related reminders, the location on the screen in each time slot, and/or the order and/or timing of the presentation of promotional content, for example as further described below. It should be noted that the interactive components may only be presented on the viewers menu, allowing her to determine whether to expand or otherwise use some or all of the interactive components. Optionally, the component server 101 manages a timeline record for each visual content item, such as a video file, a video stream and the like. In such a manner, different interactive components may be associated with different time slots of the visual content item. The timeline record may record which interactive components are available in each time slot of the related visual content item.

According to some embodiments of the present invention, the component server 101 includes the commerce module 103. The commerce module 103 optionally manages client accounts for some or all of the content providers 109. As described above, the content provider may designate or select one or more interactive components for one or more visual content items it provides. The client account allows billing the content provider 109 for the interactive components it selects and/or documenting its selection for analysis and/or other usages.

Optionally, each one of the interactive components may have a different tariff and/or terms, for example a pay per actual use payment model, a pay per presentation model, a pay per client terminal, and so on and so forth. In such an embodiment, the client account of the content provider is billed according to the payment model of the interactive components it selected.

According to some embodiments of the present invention, some or all of the interactive components are provided by component providers 108, such as commercial and private entities, such as designers, programmers, and other creators. In such embodiments the component server 101 is designed to provide component providers 108 with an access to a GUI, or any other interface, that allows them to upload one or more interactive components to the interactive components gallery. Optionally, the GUI further allows defining the related payment method, providing payment details, monitoring usage, and the like.

Optionally, the commerce module 103 manages a client account for each one of the component providers 108. The client account of a certain component provider may be credited whenever one or more of interactive components it uploaded are used, installed, accessed, and/or selected. Optionally, the crediting is performed according to a payment model that is defined for it. In such an embodiment, the component server 101 provides a commerce platform that allows component providers 108 to provide content providers 110 with interactive components that enhance their visual content, provide content providers with a monitoring tool, and/or provide an interactive tool that allows consumers to react to their visual content items, optionally for a return. It should be noted that some interactive components may be provided without charge. In such embodiments, the component server 101 is used to manage a marketplace for interactive components integration and optionally for advertising, as further described below. The marketplace allows component providers 108 and content providers 110 perform various transactions, such as licensing usage rights, purchasing usage rights, purchasing interactive components, transacting interactive components multiple and/or single use licenses and the like.

According to some embodiments of the present invention, the component server 101 allows advertisers 107 to purchase advertising spaces on the dynamic layer that is superimposed on the visual content, for example on one or more containers as described below, and/or on the related interactive components. Optionally, the component server 101 comprises an advertisement module 122 that receives promotional content from the advertisers 107 and manages the embedding thereof in certain interactive components from the interactive components gallery, in a designated interactive component banner, and/or during a selected media item. Optionally, the component server 101 manages an advertising space list that documents the available advertising spots which are available for each interactive component and/or interactive component banner in different time slots of different visual content items.

Optionally, in use, the advertisement module 122 presents a designated GUI or any other interface to advertisers 107. The GUI presents the advertisers 107 with the available advertising spots and optionally with the tariff and/or payment method of each advertising spot. Optionally, the GUI allows the advertisers 122 to upload or otherwise indicate the promotional content they are interested to embed, for example by loading or otherwise providing a banner, an interactive component, a pop up, an image, a video clip, an audio file, text and any other form of promotional content. Optionally, the advertisement module 122 presents available advertising spots according to the medium in which the promotional content is provided.

It should be noted that the selection of available advertising spots may be performed automatically, for example according to an advertisement engine that purchases the advertising spots according to a set of predefined rules.

In such an embodiment, an advertiser may purchase an advertising spot on one or more interactive components which are about to be superimposed on a display of a certain video, such as a television show. Optionally, the advertisement module 122 allows advertisers 107 to upload promotional content and to designate it to advertising spots and/or video content items. In such an embodiment, the promotional content of the advertiser is presented on advertising spots of interactive components which are associated with the designated video contents and/or superimposed thereon. Optionally, the advertisement module 122 allows advertisers 107 to select a time slot for the presentation of their promotional content. In such an embodiment, the timeline record of the related visual content item is updated to document the advertiser selection.

Optionally, the commerce module 103 manages a client account for each advertiser. The client account is updated according to the tariff and/or the payment method of each advertising spot they purchase. Optionally, the commerce module 103 credits the client account of the content provider and/or component provider according to the tariff and/or the payment method of related purchased advertising spot. In such a manner, the component server manages a marketplace for advertising spots in which the advertisers 107 may purchase, select, and/or use advertising spots which are made available by the content providers 109 and/or the component providers. Optionally, the commerce module 103 manages various advertising models, for example advertising on interactive components and/or during the display of visual content which are related to a certain topic, period and/or keyword. Another advertising model may be targeted advertisement. In such an embodiment, the advertisement module 122 may select a group of client terminals 110 according to a match between a profile of their users and a profile of a potential customer that is optionally received from an advertiser, for example when uploading a promotional content.

Reference is now made, once again, to FIG. 3. As described above, the component server 101 allows content providers 109 to make a selection of interactive components from the component repository 105 and to associate them with one or more visual content items so as to allow the superimposition thereof during the display of the visual content items. Optionally, as described above, the component server 101 further allows associating different selections with different time slots of a visual content item. Now, as shown at 203, the presentation of the interactive components is synchronized to coincide with the display of the visual content by one or more of the client terminals 110. Optionally, the synchronization is performed according to the timeline record of each video content item.

Optionally, the synchronization instructions are defined in advance, for example when the visual content is a media file that is available online and/or VOD content. In such an embodiment, the interactive components are added in slots which tagged by the content provider and/or events which are tagged manually and/or automatically. For example, events such as a transition to promotional content, a scene without a dialog, a scene without a motion and the like may be automatically identified by an image and/or audio analysis, for example, speech-to-text analysis, content processing analysis, natural language processing analysis and/or a combination thereof. Optionally, the events are manually selected by the content provider.

Optionally, the synchronization is performed in real time, for example when the visual content is a live broadcast. According to some embodiments of the present invention, the distribution module 102 synchronizes between the visual content and some or all of the members of the selection according to a classification, a tagging, and/or a clustering of the visual content. Optionally, video streams and/or files are classified, clustered and/or tagged according to various known video classification methods, for example according to image processing, audio analysis, and/or metadata that is attached thereto and/or placed in the hosting websites. Optionally, the synchronization is performed according to the classification and/or the metadata.

As shown at 204, the selected interactive components are superimposed on the display in a synchronic manner. As described above and depicted in FIGS. 1 and 2, the content providers 109 forward, stream, and/or broadcast the visual content items to the client terminals 110, via the communication network 106 and/or the multimedia distribution network 121.

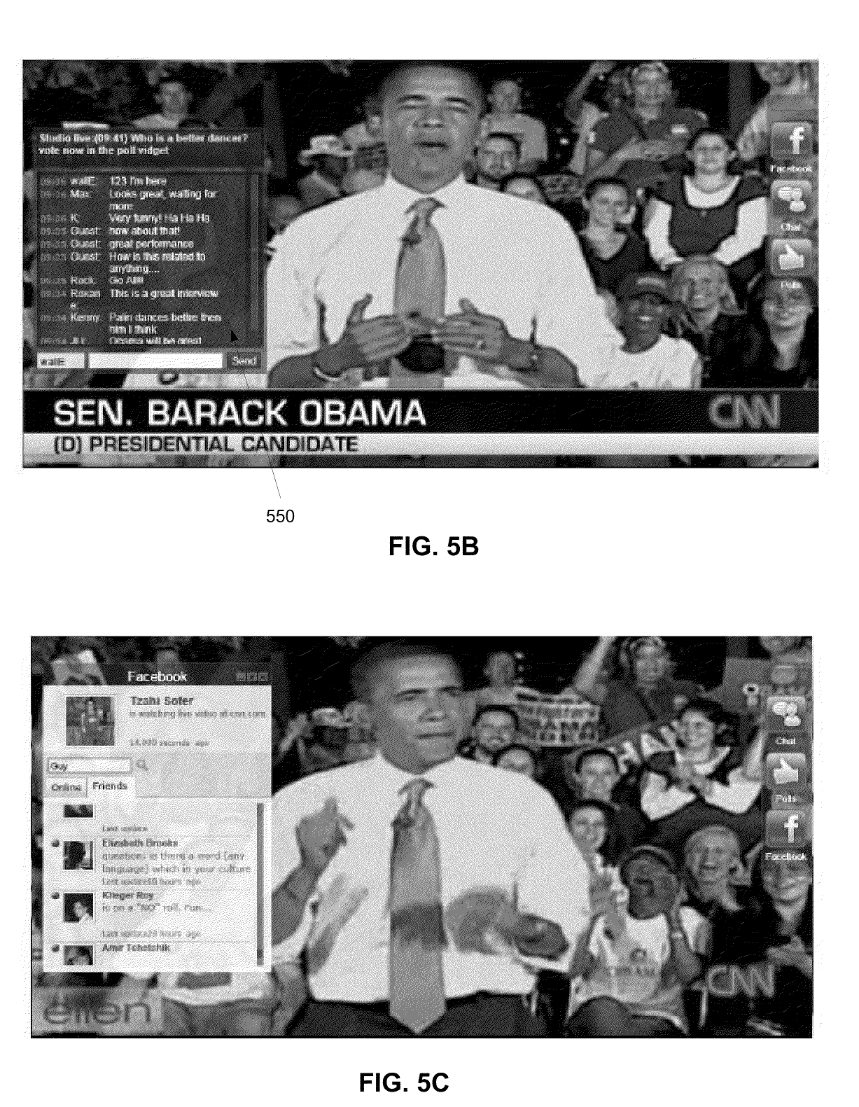

The selected interactive components may be superimposed as a transparent or translucent overlay and/or as a sidebar, for example as respectively depicted numerals 501 and 502 of FIG. 5A. The display of the selected interactive components may be referred to herein as a dynamic layer of interactive and optionally updatable data that is superimposed on a display of the visual content, for example dynamic layer of containers as described below.

According to some embodiments of the present invention, an interactive component engine, referred to herein as a client components engine, is installed on each one of the client terminals 110, optionally as an add-on or a plug-in of one or more media players which are installed thereon. Optionally, the client components engine includes a Flash Plug-in, such as a Shockwave Flash (SWF) Plug-in that is loads the interactive components into a video player, such as a FLEX based media player and a Silverlight™ player. Optionally, the client components engine is installed as a wrapper element that loads the video player and transparently adds the dynamic layer as known in the art. Optionally, the client components engine is bundled with a Flash Video player. In such an embodiment, the client components engine is integrated into the video player. Additionally or alternatively, the client components engine includes a flash box component that is designed to display the interactive components on a separate window next to the video player display, for example when the video player display is minimized and/or in a small screen mode. Optionally, the client components engine includes a Silverlight™ Plug-in suitable for windows video formats. Optionally, the client components engine is bundled with a Silverlight™ video player, similarly to the described above.

According to some embodiments of the present invention, an interactive component engine manages a dynamic layer of one or more containers that contain the interactive components which are presented on the display of visual content items. The one or more containers are optionally controlled according to instructions from the user of the media player and/or instructions which are received from the interactive components distribution module 102, optionally according to the timeline record of the related visual content items and/or according to analysis of real time events, for example as monitored by the monitoring module 123 which is further described below.

Optionally, each container, for example as shown in numeral 550 of FIG. 5B, allows interactively adjusting the display of the one or more interactive components it contains. For example, the container may allow maximizing the one or more interactive components, minimizing the one or more interactive components, relocating the one or more interactive components, for example by drag and drop functions, and the like. In use, a container with the contained interactive components is displayed when the user selects the one or more interactive components it contains, for example by clicking on the icons which are superimposed on the display. Optionally, the container allows displaying various interactive components from different sources, for example a Facebook™ widget, as shown at FIG. 5C and a interactive component which is related to the displayed visual content item, such as a poll, for example as shown at FIG. 5D or a chat as shown at FIG. 5B. It should be noted that while instructions affecting the interactive component data are acquired from a certain source, instructions for controlling the container are received from another source, namely, the component server 101.

Optionally, the container allows displaying promotional content in a association with a certain visual content item and/or with a certain interactive component, as shown in numeral 551 of FIG. 5E.

Optionally, data pertaining to the manipulating of the container, for example minimizing and/or maximizing the container, is gathered and forwarded to the component server 101, optionally to the monitoring module 123, as described below. In such a manner, the monitoring module 123 may provide a real time analysis of the viewer interactions with the contained interactive components. As outlined above, the containers may be controlled by the component server 101. In such a manner, the system operator may remotely control the status of the interactive component the presentation thereof. For example, the container may be manipulated real time and the promotional content may be added to, changed on, and/or removed from the advertisement spot in real time and/or according to a predefined schedule or set of rules. Optionally, different statistical data may be extracted from the containers managed on a plurality of client terminals such that actual statistic may be gathered in real time, for example the number of client terminals having a certain interactive component maximized and the like. In such an embodiment, the containers, which are maximized or otherwise activated, allow gathering data about the viewers which are watching a certain visual content item and optionally ready to participate in a social activity, such as chatting or voting. For example, the container may display to a certain viewer which of her friends, for example a Facebook™ friend or a Skype™ content is currently watching the same visual content item she is watching.

Optionally, the component server 101 changes the appearance of the containers and/or interactive components in real time. For example, a background image may be controllable and/or the color or transparency of the interactive components. The container may also set the size and the opacity level of the contained interactive component.

As the container adjusts the interactive components and the dynamic data it displays it allows using any interactive component as an interactive component which is dynamically superimposed on a display of a visual content item, such as a video stream. By using containers the system 100 function as a platform that can embed any interactive component on a display of a media player or the like.

According to some embodiments of the present invention, the system 100 comprises a viewer module that provides the viewers with an access to a GUI via their client terminals 109. As described above, the component server 101 manages an interactive components gallery. Optionally, the GUI allows the accessing viewers to select interactive components. Optionally, the billing module manages viewer accounts and bills them for the selected interactive components, optionally according to respective payment methods. Optionally, the viewers may add interactive components which are not in the gallery, optionally by providing a reference, such as a link, thereto. In such an embodiment, a container may be used for adjusting the added interactive component. Optionally, the component server 101 may manage an interactive component store for each content provider, for example as a based on a software as a service (SaaS) model, In such an embodiment, each content provider that uses the component server 101 to enrich its visual content items may define a Gallery of available interactive components in a webpage, such as a commonly known AppStore. Optionally, each content provider may specify which interactive components are available for the viewers and optionally the payment model for them, for example which interactive components are free and which are for a charge. The interactive component store is managed as a market place where third parties, such as widget developers, offer their widgets to the content provider that in turn chooses which widgets for its gallery. The widget developer may set a minimum price per view and/or use. The billing module handles the billing and the revenue sharing between the widget developer and the content provider. Alternatively some widget developers, for example brands and advertisers may choose to pay content providers for adding their interactive component to their gallery.

According to some embodiments of the present invention, the client components engine is installed on client terminals 110 which are connected to the multimedia distribution network, such as set top boxes and televisions with internet connection. In such an embodiment the client components engine is designed for TV-centric viewing and easy control and navigation on the interactive components using the TV's remote control. The client components engine may be provided and/or customized by XML layout. The client components engine allows viewers to navigate, select and interact with the interactive components which are loaded for the displayed video content items which are displayed on their client terminal.

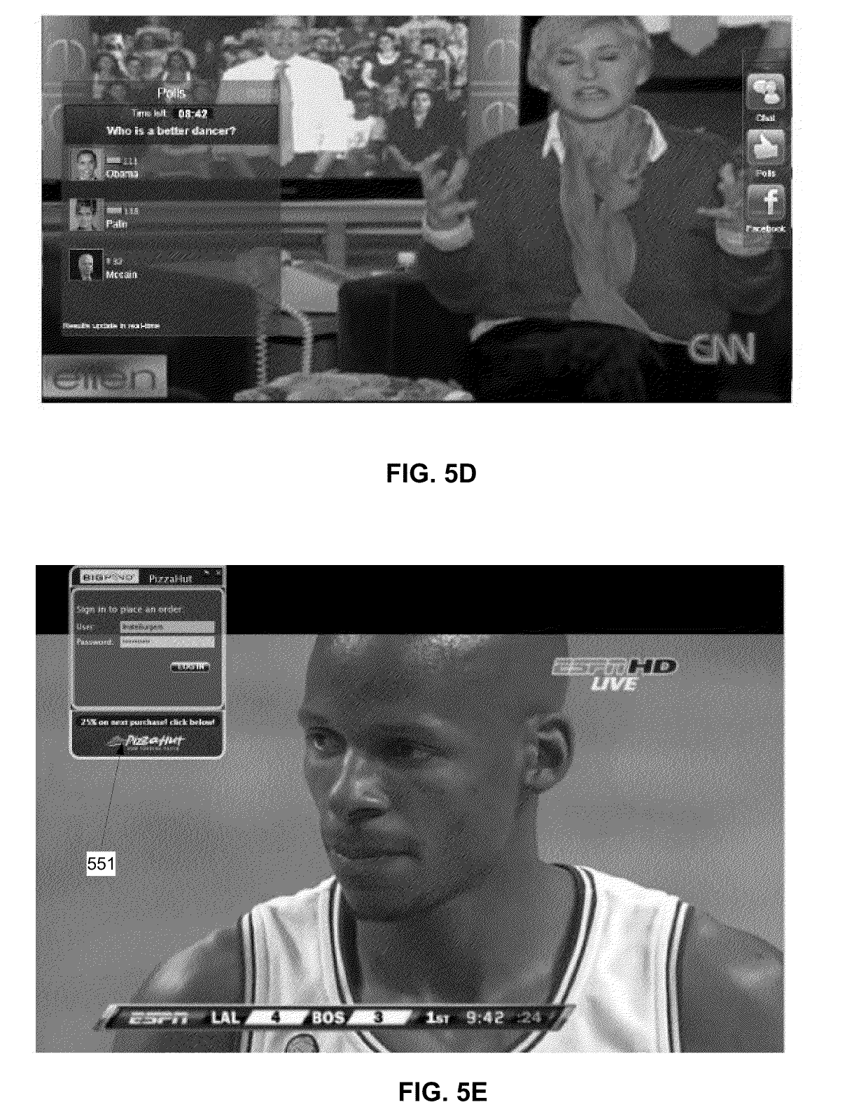

The client components engine manages the presentation and the viewer interaction with the interactive components. For example, reference is now also made to FIG. 6, which is a flowchart of a method for superimposing interactive components on a display of a media player, such as a Silverlight™ video player and a Flash™ video player, according to some embodiments of the present invention. First, as shown at 351, a visual content, such as a video stream, a file, or a broadcast, is selected for presentation using the hosting media player. Now, as shown at 352, the client components engine acquires from the component server 101 the selected interactive components. Optionally, the data may be acquired by a regular hypertext transfer protocol (http) session. As shown at 353, the presentation of the received interactive components is synchronized with the display of the selected video content item. Now, as shown at 354, after the relevant interactive components is loaded and optionally synchronized, the client components engine manages the superimposition of the interactive components on the selected visual content. Optionally, as shown at 355, the client components engine updates the superimposition according to the timeline record of the visual content. The timeline record is optionally acquired in a similar manner to the acquisition of the interactive components.

Optionally, the client components engine manages real-time interactions with component server 101. In such an embodiment, the component server 101 may send an update to the timeline record, new interactive components, and/or changes and/or instructions to the interactive components in the loaded interactive components. In such an embodiment, the component server 101 may instruct the client components engine to pop-up one or more interactive components, optionally according to the timeline record and/or to pop-up a teaser to one or more interactive components and/or advertisement, for example according to instructions from the advertisement module 122, optionally according to the time line record. Optionally, the client components engine wraps the interactive components with promotional content, optionally according instructions of the advertisement manger 122.

According to some embodiments of the present invention, the client components engine monitors viewer interaction with some or all of the interactive components. The monitored viewer interactions are forwarded to the analysis module 111 of the component server 101. As used herein, a viewer interaction with an interactive component means maximizing an interactive component, minimizing an interactive component, updating a field in an interactive component, for example by typing text, making a change, and/or performing a selection, clicking on a link presented on an interactive component, dragging an interactive component, playing an interactive component and/or performing any other action with the interactive components. Optionally, the client components engine monitors duration each interactive component has been used, and the location of the interactive component on a display.

According to some embodiments of the present invention, the client components engine forwards some or all of the monitored viewer interactions to the component server 101. In such an embodiment, the component server 101 may include an interactive component module that manages the interactive components according to the monitored interactive component. In such embodiments, some or all of the monitored interactive components communicate with the interactive component module in order to perform some or all of their functions. For example, a weather widget requests current promotional content from the interactive component module and a current weather data from another remote server. Such communication takes place according to well-known techniques for requesting and receiving information across a network such as the Internet: the interactive component or the client components engine forms a request for data, and transmits the request according to HTTP or some other network protocol; the component server 101 responds to the request with the information; and the interactive component uses the information in forming an output that will be superimposed on the display of the visual content item for the user. In one embodiment, these operations take place in response to JavaScript code within the interactive component. If desired, the information can be transmitted across a secure channel and/or encrypted prior to transmission, according to techniques that are well known in the art.

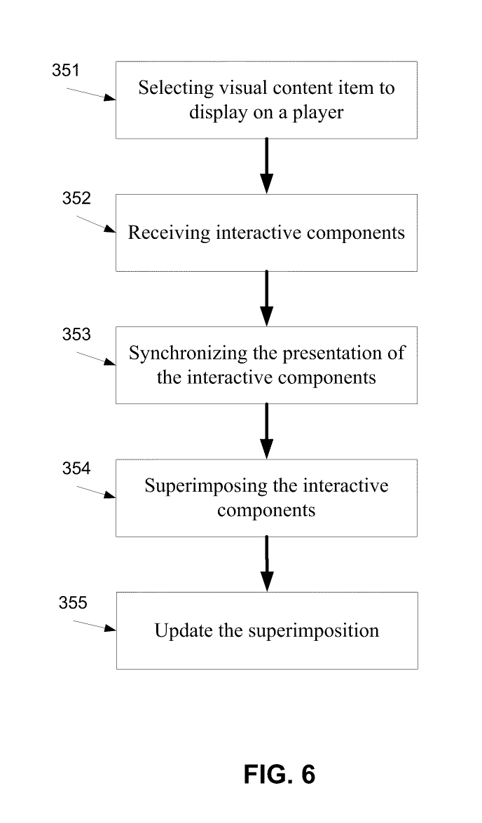

According to another example, the interactive component module of the component server 101 is used for moderating correspondences which are performed using interactive components, such as a chat widget. Fog example, FIG. 7 depicts an image of an exemplary GUI that allows an operator to monitor correspondences which are performed using a chat widget.

According to some embodiments of the present invention, the component server 101 includes a monitoring module 123. The monitoring module 123 gathers data pertaining to monitored viewer interactions, for example as received from the client components engines which are installed on the various client terminals 109, and analyzes it. In such a manner, the monitoring module 123 facilitates content and/or component providers and/or advertisers to monitor viewer interactions pertaining to interactive components which are presented on selected visual content items and/or with selected interactive components, optionally during the presentation thereof, namely in real time. For example, the monitoring module 123 allows watching statistical data such as number of users of a certain interactive component during the presentation thereof. For example, the component server 101 may be provide one or more of the content providers 110 with statistical data pertaining to the visual content items they are currently provide, for example which and how many subscribers are watching, what is the relation between the viewers and certain demographic groups, which and how many viewers interact with the presented interactive components, which interactive components receive more attention and the like.

Optionally, the monitoring device manages the containers of the interactive components according to the gathered data. For example, a group of viewers is selected for advertizing and/or for any other activity according to their level of activity, usage pattern, and/or according to their relation to a certain demographic group. The selected group is then presented with promotional content, optionally using a pop-up and/or by changing the content of a banner in one or more containers. Optionally, the selected group is presented with one or more additional interactive components or promotions thereto. In such an embodiment, different interactive components may be associated with different groups of viewers, for example according to their geographical location, common usage patterns, and/or common usage history. The system may also be configured to pop-up a promotional content to viewers when they interact with the respective interactive components. For example, a pop may be presented to a viewer N seconds, for example 5, after he interacted with an interactive component which is superimposed on the display. In such n embodiment, the advertiser receives an indication that the viewer is present and active during the presentation of the promotional content. In addition, the component server 101 collects the viewer interactions pertaining to the visual content items. For example, in a sports event the system may collect information on interactive actions during different periods of the game, during the break time etc.

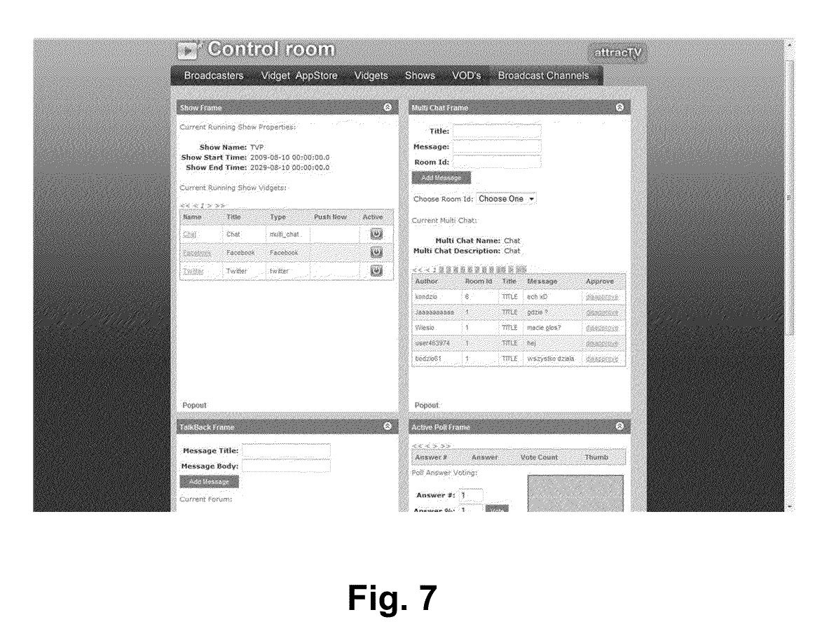

For example, reference is now made to FIG. 8, which is an image of an exemplary GUI for displaying statistical data pertaining to the monitored interactions between user selected interactive components, according to some embodiments of the present invention. As depicted in FIG. 8, the GUI displays the number of users which have used selected interactive components, such as a Facebook™ widget, a chat widget, and a twitter™ widget and the accumulated usage duration in each one of these interactive components.

The data gathered by the monitoring module 123 may be used for calculating the credit and/or the debit of each content and/or component provider, estimating the exposure of users to a certain promotional content that is presented using one or more of the interactive components, and/or estimating the interest users have in the visual content item which is presented thereto.

According to some embodiments of the present invention, the monitoring module 123 gathers and analyzes data pertaining to a certain interactive component. In such a manner, the monitoring module 123 may provide real time information about the opinions and/or the selections of a plurality of users with regard to a certain visual content item that is presented to them, optionally simultaneously. The analyzed data may be used for targeted advertisement, optionally in real time.

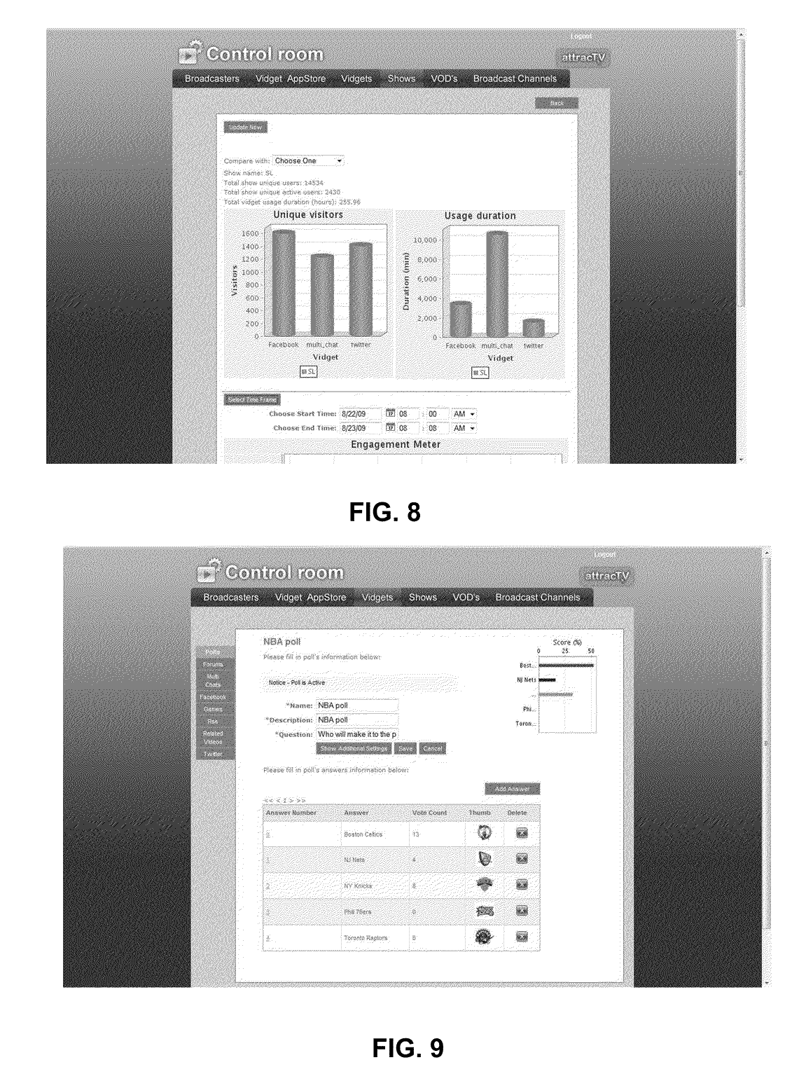

An example for such analysis is provided in FIG. 9, which is an image of an exemplary GUI displaying an outcome of a pool held by a poll widget that is superimposed on a visual content item, such as a NBA game, according to some embodiments of the present invention. Another example for such a data analysis is a polling widget that is superimposed on a visual content item, such as a live broadcast, for example American Idol, Beauty contest, song contest, such as American Idol and Eurovision, a reality show, such as the Big brother, and the like. It should be noted that as the monitoring module 123 may gather and analyze data in real time, users may affect the outcome and/or the proceeding of the live broadcast.

Optionally, the monitoring module 123 records the monitored viewer interactions so as to allow the presentation thereof as a performed during the display of the associated visual content item. In such a manner, the content provider may analyze the activity of users during the presentation of the visual content. Optionally, such a recording allows the monitoring module 123 to replay the arrangement and/or status of each one of the interactive component during the display of the associated visual content item to the user, for example when replaying a visual content item, such as a VOD record.

According to some embodiments of the present invention, the client components engine allows the viewer to control the interactive components, drag and drop interactive components on the display of the player or the screen, minimize, maximize and pin the interactive components, store preferences of each interactive component, and/or store general interactive component preferences.

It is expected that during the life of a patent maturing from this application many relevant systems and methods will be developed and the scope of the term broadcasting, displaying, presenting, a visual content item, and an interactive component is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc, as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A computerized method for superimposing interactive components on a visual content displayed on at least one client terminal, comprising:
receiving, from a content provider of a visual content item, a designation of at least one interactive component from a plurality of interactive components; associating, using a processor, -between said designation and said visual content item; and
forwarding said designation to a client terminal so as to allow a presentation of said at least one interactive component, said presentation being synchronized to coincide with a display of said visual content item by each of a plurality of client terminals connected to a network;
wherein said at least one interactive component is superimposed on said display during said presentation;
monitoring a plurality of interactions of a plurality of viewers with said at least one interactive component during said display; and
updating said presentation according to an analysis of said plurality of interactions.

2. The method of claim 1, wherein said visual content item is selected from a group consisting of a video stream, a video transmission, a video unicast, a video, a video file, an animation file, an animation steam, a video in demand (VOD) record, an animation transmission, a presentation file, a presentation steam, an online game, a presentation transmission.

3. The method of claim 1, wherein said plurality of client terminals are selected from a group consisting of computers, Smartphones, laptops, netbooks, personal digital assistant (PDAs), Internet Protocol Television (IPTV) devices, cell phones, game consoles and set top boxes, televisions (TVs).

4. The method of claim 1, wherein said designation define for a group of said at least one interactive component a time slot during said display, said group being displayed during said time slot.

5. The method of claim 1, further comprising managing a timeline for each said visual content item and updating said presentation according to said timeline.

6. The method of claim 1, further comprising monitoring at least one event held on at least one of said plurality of client terminals and updating said presentation according to said at least one event.

7. The method of claim 1, further comprising embedding promotional content into at least one of said at least one interactive component and an additional component superimposed on said display.

8. The method of claim 1, further comprising analyzing said visual content item and changing said presentation according to said analyzing during said display.

9. The method of claim 8, wherein said analyzing is performed substantially during said display.

10-11. (canceled)

12. The method of claim 1, further comprising generating a report according to said plurality of interactions.

13. The method of claim 12, wherein said generating is performed during said display.

14. The method of claim 1, further comprising recording said plurality of interactions and playing said plurality of recorded interactions during a replay of said visual content item.

15. The method of claim 1, further comprising monitoring at least one viewer interaction with said at least one interactive component during said presentation so as to allow at least one of changing said presentation, removing said at least one interactive component, and presenting a report according to said at least one viewer interaction.

16. The method of claim 1, wherein said at least one interactive component allows presenting content pertaining to said visual content item.

17. A system for superimposing interactive components on a visual content displayed on at least one client terminal, comprising:
a processor;
a repository hosting a plurality of interactive components;
a distribution module, executed by said processor, for receiving a designation of at least one of said plurality of interactive components for a visual content item via a communication network and transmitting said designation to a plurality of client terminals so as to allow each said client terminal to synchronize a presentation of said at least one interactive component to coincide with a display of said visual content item.

18. The system of claim 17, wherein each said client terminal comprises a player having a client engine for performing said presentation and said display.

19. The system of claim 17, wherein each said client terminal comprises a player wrapped in a client engine so as to allow the performing of said presentation and said display.

20. The system of claim 19, wherein said client engine manages at least one container for containing said at least one interactive component so as to allow the performing of said presentation; wherein said at least one container facilitate at least one of manipulating said at least one interactive component, changing the size of said presentation, and relocating said presentation.

21. The system of claim 17, wherein said distribution module is configured for receiving a consumer profile and selecting said plurality of client terminals according to a match between said consumer profile and a plurality of client profiles associated with said plurality of client terminals.

22. The system of claim 17, further comprising an advertising module for receiving promotional content and for at least one of embedding said promotional content in said at least one interactive component during said presentation and instructing said plurality of client terminal to present said promotional content during said display.

23. The system of claim 17, further comprising a commerce module for billing a provider of said visual content item according to said designation.

24. The system of claim 17, further comprising a viewer module for receiving a designation of at least one of said plurality of interactive components and adding said at least one interactive component to said presentation.

25-29. (canceled)

30. A computerized method for superimposing interactive components on a visual content displayed on at least one client terminal, comprising:
receiving a designation of at least one interactive component from a first source via a communication network;
receiving a visual content item from a second source;
providing at least one container for containing said at least one interactive component;
generating, using a processor, a presentation of data from said at least one interactive component in said at least one container;
superimposing-, using said processor, said at least one container on a display of said visual content item; and
allowing a user to manipulate said at least one container so as to adjust said presentation.

31. The method of claim 30, wherein said visual content item is received from a multimedia distribution network, said communication network being the Internet.
